(19) United States
(12) Patent Application Publication
(10) Pub. No.: US 2016/0284010 A1
(43) Pub. Date: Sep. 29, 2016

(54) METHOD AND SYSTEM FOR PREVENTING SHOPPING CART ABANDONMENT

(71) Applicant: Personali Inc., Waltham, MA (US)

(72) Inventors: Keren ZIMMERMAN, Tel Aviv (IL); Noam JAVITS, Tel Aviv (IL)

(73) Assignee: Personali Inc., Waltham, MA (US)

(21) Appl. No.: 15/164,272

(22) Filed: May 25, 2016

Related U.S. Application Data
(63) Continuation of application No. PCT/US2014/069303, filed on Dec. 9, 2014.
Application No. PCT/US2014/069303 is a continuation-in-part of application No. PCT/US2014/056743, filed on Sep. 22, 2014.
(60) Provisional application No. 61/914,420, filed on Dec. 11, 2013.
(60) Provisional application No. 61/881,361, filed on Sep. 23, 2013.
(60) Provisional application No. 61/908,757, filed on Nov. 26, 2013.

(51) Int. Cl. G06Q 30/06; G06Q 50/18

(52) U.S. Cl. CPC G06Q 30/0633; G06Q 50/188

(57) ABSTRACT

A method and system for preventing electronic shopping cart abandonment in an electronic commerce (e-commerce) website are provided. The method includes receiving by an e-commerce server a message that at least one product is added to an electronic shopping cart of the e-commerce website displayed on a consumer device; collecting by the e-commerce server at least one user-activity parameter related to a user of the consumer device; identifying, using the at least one user-activity parameter, an attempt of a user of the consumer device not to complete a purchase transaction of the at least one product; selecting at least one motivational content item for display on the consumer device; and causing a display of the selected at least one motivational content item on a display of the consumer device.

### CROSS REFERENCE TO RELATED APPLICATIONS

This application is a continuation of International Application No. PCT/US2014/069303 filed on Dec. 9, 2014 which claims the benefit of U.S. Provisional Application No. 61/914,420 filed Dec. 11, 2013. This application is also a continuation in part of an International Application No. PCT/US14/56743 filed Sep. 22, 2014, which claims the benefit of U.S. Provisional Patent Application No. 61/881,361 filed Sep. 23, 2013, and U.S. Provisional Patent Application No. 61/908,757 filed on Nov. 26, 2013. The contents of the above mentioned applications are incorporated herein by reference for all that they contain.

### TECHNICAL FIELD

The disclosure generally relates to a computerized negotiation platform for electronic commerce (e-commerce) websites, and more specifically to a system and method for preventing users from abandoning electronic shopping carts in e-commerce websites.

### BACKGROUND

The way people shop has significantly progressed since the development of the worldwide web (WWW). Consumers can now shop from the convenience of their home, office, or while on the road using portable devices. Popular e- commerce websites, such as Amazon.com® and Shopping.com®, though different by nature, allow consumers to purchase goods and services directly through the website, sometimes at a much lower price than the price suggested by local merchants. From a merchant's point of view, it allows access to a worldwide market of consumers.

The services provided by e-commerce websites such as Shopping.com® belong to a category of websites that provide comparison shopping engines (CSE) that assist consumers by presenting prices and information about a product the consumer may be interested in purchasing. In response to a consumer's query, the consumer is provided with a list of possibilities based on characteristics such as price and popularity. The CSE is generally considered to be an effective tool for consumers.

As another example, Priceline.com® allows a consumer to make a bid for a traveling service, such as a hotel room reservation. In response, the service provider (e.g., either Priceline.com® or the hotel), can either accept or reject that bid. In response, the consumer can either search for another alternative or raise the bid until it is accepted by the service provider. The disadvantage of such an approach is that the consumer does not know the particulars of the vendor or service provider. For example, the consumer selects the area and rating of a hotel he or she desires to stay at, but the consumer cannot bid on a specific hotel. Further, all bids placed by the consumer are binding and no true negotiation take place.

Other disadvantages typically associated with e-commerce websites relate to the lack of personal interaction between the consumer and the merchant. At best, the personal interaction is limited to a chat with a sale representative who can provide more information about the goods/services that can be purchased through the e-commerce web-site. Another way to motivate consumers to purchase through e-commerce websites is to offer generic discounts to all the consumers visiting the website. Therefore, consumers are less inclined to follow through on an online purchase and abandon their electronic shopping carts.

It would therefore be advantageous to overcome the limitations of the prior art e-commerce solutions by providing an effective and personalized solution to motivate consumers to purchase online.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

The disclosure relates to exemplary embodiments of a method for preventing electronic shopping cart abandonment in an electronic commerce (e-commerce) website. The method comprises receiving by an e-commerce server a message that at least one product is added to an electronic shopping cart of the e-commerce website displayed on a consumer device; collecting by the e-commerce server at least one user-activity parameter related to a user of the consumer device; identifying, using the at least one user-activity parameter, an attempt of a user of the consumer device not to complete a purchase transaction of the at least one product; selecting at least one motivational content item for display on the consumer device; and causing a display of the selected at least one motivational content item on a display of the consumer device.

The disclosure further relates to exemplary embodiments of a system for preventing electronic shopping cart abandonment. The system comprises a processor; and, a memory coupled to the processor, the memory containing instructions that, when executed by the processor, configure the system to: receive by an e-commerce server a message that at least one product is added to an electronic shopping cart of an e-commerce website displayed on a consumer device; collect by the e-commerce server at least one user-activity parameter related to a user of the consumer device; identify, using the at least one user-activity parameter, an attempt of a user of the consumer device not to complete a purchase transaction of the at least one product; select at least one motivational content item for display on the consumer device; and cause a display of the selected at least one motivational content item on a display of the consumer device.

### BRIEF DESCRIPTION OF THE DRAWINGS

The subject matter disclosed herein is particularly pointed out and distinctly claimed in the claims at the conclusion of the specification. The foregoing and other objects, features, and advantages of the embodiments will be apparent from the following detailed description taken in conjunction with the accompanying drawings.

FIG. 1 is a schematic diagram of a network system describing the various embodiments for preventing shopping cart abandonment according to an embodiment.

FIG. 2 is a flowchart describing a method for preventing shopping cart abandonment accordance with an embodiment.

FIGS. 3A and 3B are screenshots showing a delayed display of content in accordance with an embodiment.

### DETAILED DESCRIPTION

The embodiments herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

As an example of the above, some exemplary embodiments disclosed herein configure a system and method to motivate users to complete an online purchasing transaction. Without limiting the scope of the disclosed embodiments, a product or products disclosed herein include goods and/or services. The disclosed method is performed during a browsing session of an e-commerce website, which thereby may prevent a user (e.g., a consumer) from abandoning a shopping cart and to complete the purchase transaction of products included in the electronic shopping cart.

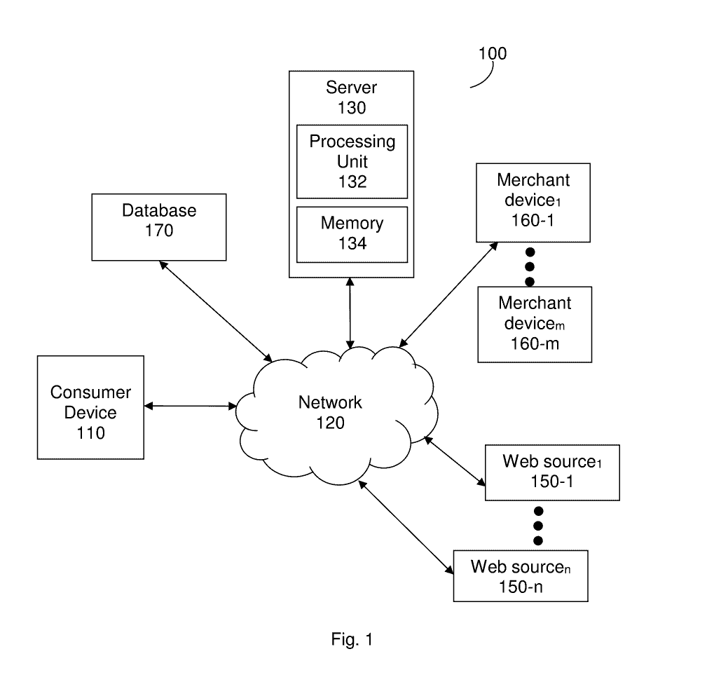

FIG. 1 depicts an exemplary and non-limiting schematic diagram of a system 100 utilized to describe the various disclosed embodiments. A user, by means of a consumer device 110, is connected to a network 120. The device 110 may be, but not is limited to, a personal computer (PC), a laptop computer, a smart phone, a tablet computer, a wearable computing device, and the like. The consumer device 110 is configured to allow access to one or more web sources 150-1 through 150-n (collectively referred hereinafter as web sources 150 or individually as a web source 150, merely for simplicity purposes) for at least the purpose of performing e-commerce transactions. As an example, a web source 150 may be a website or a datacenter that hosts an e-commerce website. It should be noted that e-commerce website may be, but is not limited to, online websites, travel websites, services websites, and any other web source through which the user is able to purchase goods or services. It should be further noted that e-commerce websites may be accessed through a web browser or an application installed on the consumer device 110.

The network 120 can be wired or wireless, a local area network (LAN), a wide area network (WAN), a metro area network (MAN), the Internet, the worldwide web (WWW), the likes, and any combinations thereof.

An e-commerce server 130 is further connected to the network 120. The e-commerce server 130 typically comprises a processing system 132 that is coupled to a memory 134. The memory 134 contains instructions that when executed by the processor system 132 results in the performance of the methods discussed herein below. Specifically, the memory 134 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). In an embodiment, the processing system 132 may include one or more processors. The instructions, when executed by the one or more processors, cause the processing system 132 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The consumer device 110 can communicate with the web sources 150 over the network 120. In an embodiment, communication between consumer device 110 and the web sources 150 is facilitated through the e-commerce sever 130. The web sources 150-1 through 150-n are operative by merchant devices 160-1 through 160-m, (collectively referred hereinafter as merchant devices 160 or individually as a merchant device 160, merely for simplicity purposes) respectively. One merchant device 160, for example merchant device 160-1, may operate one or more web sources 150 such as, for example, web sources 150-1 and 150-2. A single web source 150 such as, for example, web source 150-1, may be operated by a plurality of merchant devices 160, for example merchant device 160-1 and 160-2.

According to various disclosed embodiments, the e-commerce system 130 is configured to track the activity of a user of the consumer device 110. This can be performed using a script or other code executed over the device 110 and programmed to collect data with respect to the user shopping activity, e- commerce websites the user visits, and products placed in shopping carts. In an embodiment, the e-commerce server 130 is configured to receive a message that a user currently browsing an e-commerce website hosted by one of the web sources 150. The message may also provide an indication that a product was placed in a shopping cart of an e-commerce website. Such a message is sent, for example, from the consumer device 110, as the product is placed in the shopping cart. The message or messages that the user browses an e-commerce website and/or adds products to the carts may be derived by a script or from a cookie (or similar data structures) saved locally in the consumer device 110. The received message may include, for example, a full list of products or a partial list of products (each product identified by its name or any other unique identifier) in the shopping cart. The message may also include a current price of each such product, a time that the product was added to the cart, and/or the quantity of each product.

In an alternative embodiment, the message that the user added a product to a shopping cart may be provided by the web source 150 hosting the respective e-commerce website. Such a message may also include an identifier of the user and/or consumer device 110.

Upon identification that a product is added to the shopping cart, the e-commerce server 130 is configured to collect one or more parameters related to the activity of a user of the consumer device 110 through the web source 150. Such identification may be provided by a script executed on the consumer device 110 in response to accessing the e-commerce website. Alternatively or collectively, identification may be derived from a cookie (or similar data structures) saved locally in the consumer device 110. It should be noted that access to the e-commerce website hosted on web source 150 can be from a browser, an application (app) installed on the consumer device 110, and the like.

The user activity parameters may include, but are not limited to, an amount of time the user spent searching for a certain good or service, one or more gestures received from the user of the consumer device 110, queries or portions or queries, products and their quantities in an electronic shopping cart, and so on. A gesture may include, but is not limited to, a click, tap, swipe, keystroke, or any other means of user interaction with the consumer device 110.

In one embodiment, the e-commerce server 130 is further configured to compare a collected user activity parameter to a respective baseline to identify a significance parameter. The baselines may be computed based on data collected from multiple users or data collected from a specific user. The baselines may be saved in the database 170. For example, if the average user spends 2 minutes searching for a particular product and the identified user spends 5 minutes searching for that product, then the time spent searching for the product is a significant parameter.

As part of user activity's tracking, the e-commerce server 130 is further configured to detect or identify an attempt to terminate a purchase transaction of any product placed in the electronic shopping cart. The identification of a transaction termination may be explicit or implicit. Explicit identification may be based on a message received from the consumer device 110 and/or e-commerce website that the user has removed the product from the cart and/or reduced the product's quantity. An implicit identification is based on an analysis of the collected user activity parameters. For example, the implicit identification may be based on a type of product, the duration of time elapsed since the user adds a certain product to an e-shopping cart, a user navigates away from the e-commerce website, a user browses different products, and so on, or combination thereof.

For example, a threshold of time for completing a purchase transaction for a coffee mug is 2 minutes. If 15 minutes have passed since the coffee mug has been added to the cart, the elapsed time may imply that the user intends to abandon the transaction. It should be emphasized that the identification of the attempts to terminate a purchase transaction is performed prior to the actual termination, thereby allowing the e-commerce server 130 to immediately respond to such attempt in order prevent the termination of the transaction in real-time.

Upon identification of an attempt to abandon the purchase transaction, the e-commerce server 130 is configured to select at least one motivational content item in order to prevent the user of the consumer device 110 from terminating the transaction. In an embodiment, motivational content items are selected using the user activity parameters and significant parameters computed respective thereof. In addition, the motivational content items may also be selected based on one or more parameters related to the product. Such parameters may be provided by the merchant device 160 and include, for example, a price range for a product, a current inventory level of the product, a specific promotion offered by the merchant for the product, and the like.

The motivational content items may be, for example, a discounted price to purchase a product, a discounted price for add-on products, additional services related to the product, or other incentives to complete the purchase transaction. In an embodiment, the motivational content item may be an invitation to bid on the product. The bid invitation, upon activation by the user, will initiate a negotiation process between the user and a merchant (by means of a merchant device 160). The negotiation process is facilitated by the e-commerce server 130. In an embodiment, a motivational content item is in a form of a widget. The selected motivational content items are displayed over the consumer device 110 in association with the product.

In a non-limiting example, upon identification that the user is abandoning an electronic shopping cart including a coffee mug, a widget including a price discount on the coffee mug that will be applied if the purchase transaction is completed within the next 5 minutes is selected and displayed to the user. As another example, the motivational content item may include a message stating the price of the coffee mug will increase after 5 minutes.

It should be noted that while the system 100 is described in a manner where the e-commerce server 130 is a separate device from the web source 150 it should not be viewed as a limitation of the disclosed embodiments. In certain exemplary embodiments, the e-commerce server 130 and the web source 150 may be implemented on the same physical device.

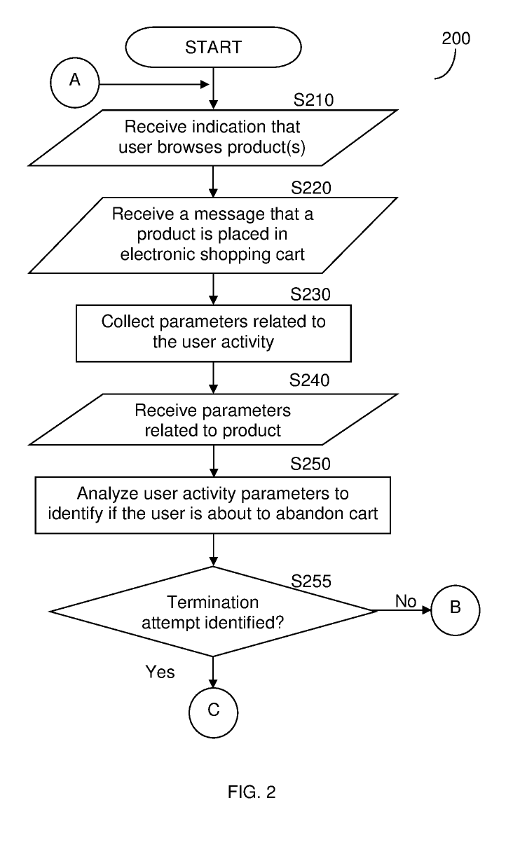

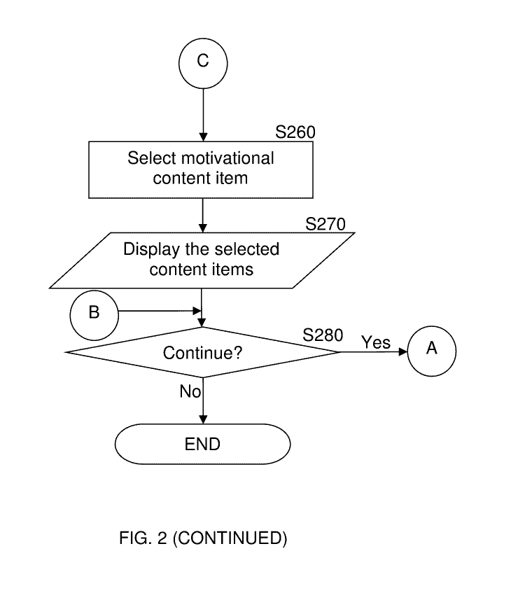

FIG. 2 depicts an exemplary and non-limiting flowchart 200 method for preventing shopping cart abandonment. In an exemplary implementation, the method is performed by the e-commerce server 130.

In S210, an indication that a user of a consumer device browses products for sale on an e-commerce website (hosted by, e.g., one of web sources 150) is received. Such an indication may be provided by a script executed on the consumer device 110 in response to accessing the e-commerce website. The indication may be derived from a cookie or similar data structure saved locally in the consumer device. It should be noted that access to the e-commerce website hosted on a web source can be facilitated by a web browser, an application (app) installed on the consumer device, and the like.

In S220, a message that at least one product has been placed to an electronic shopping cart displayed over the consumer device is received. Such a message may be received from a consumer device (e.g., device 110) or an e-commerce website (e.g., one of sources 150). As noted above, the received message may include, for example, a full list of products or a partial list of products (each product identified by its name or any other unique identifier) in the shopping cart. The message may also include a current price of each such product, a time that the product was added to the cart, and/or the quantity of each product.

In S230, user-activity parameters are collected. In an embodiment, a user activity parameter includes behavioral information, shopping history information, demographic information, the amount of time the user spent searching for a certain a product, user gestures as detected with respect to the consumer device, queries submitted or portions thereof. In an embodiment, the user-activity parameters are derived from information included in the message received in S220, for example, products added to an electronic shopping cart and their quantities, time that products have been added, and so on. The user-activity parameters can be also collected by tracking the user activity as performed across multiple e-commerce websites. In another embodiment, the user-activity parameters may also be retrieved from an external information resource (e.g., the database 170) that maintains information about the user.

In S240 parameters related to the product are received from a merchant device. In an embodiment, the product-related parameters of a product placed in the shopping cart include, for example, a type of product, a product price, shipping costs, minimum price for the product, a minimum margin for the product, an inventory level of the product, and so on.

In S250, the user-activity parameters are analyzed to identify if the user is about to abandon the electronic shopping cart. The identification may be explicit or implicit. An implicit identification is based on an analysis of the collected user activity parameters, such as, but not limited to, on a type of the product, the duration of time elapsed since the user adds a certain product to an e-shopping cart, a user navigates away from the e-commerce website, a user browses different products, and so on, or combination thereof. According to a non-limiting embodiment the implicit identification is based on significant parameters computed based on baselines saved in the database 170. The baselines may represent a normal “behavior” of a user when complete a purchase transaction. A baseline may be for each product or product type and a user-activity parameter. For example, a first baseline may represent an average time to complete a transaction for electronic appliance product, while a second baseline may represent an average time to complete a transaction for toy product.

The collected user-activity parameters are compared to their respective baselines. If a user-activity parameter's value is higher and/or lower than respective baseline's value a significant parameter is generated. As an example, if a first baseline (noted above) value is 2 minutes and time elapsed since the user place an oven in an electronic cart is 15 minutes, a significant parameter is generated. It should be that different types of significant parameters may be generated based on different compared user-activity parameters. If at least a significant parameter is been determined by the process, an implicit identification of termination is declared.

Explicit identification of termination may be based on a message received from the consumer device 110 and/or e-commerce website that the user has removed the product from the cart and/or reduced the product's quantity.

In S255, it is checked whether an attempt to terminate the transaction is identified, and if so execution continues with S260; otherwise, execution continues with S280. In S260, at least one motivational content item is selected to be displayed. The motivational content items are used to incentivize the user to purchase the products through the e-commerce website. A motivational content item may be, for example, a time limited discount coupon for purchasing the product of interest, applying a discount on the product, increasing the product's price after a configurable period of time, a link or a widget allowing the user to make provide a counter offer, and another incentives.

In an embodiment, the selection of the content item is based on the user activity parameters. Specifically, the selection of content items may be based on parameters related to the user activity on an e-commerce website used to determine the user interest in the product.

As an example, a user of the consumer device 110 adds an electronic appliance to an electronic shopping cart. Upon detection that the user navigates away from the e-commerce website, a motivational content item may be an offer for free shipping of such electronic appliance.

Alternatively or collectively, the selection of the motivational content items to display may be made by the merchant device 160. That is, the merchant device 160 provides a list of incentives, a number of available products, a merchant counter offer, and so on, to motivate the user to complete the transaction. A merchant may select any or all of the provided motivational content items to display. In an embodiment, the merchant may also input a motivational content item to be displayed. As noted above, the selection of motivational content items by the merchant device 160 is generally performed in response to recommendations provided by the e-commerce server 130.

In S270, the one or more selected motivational content items are sent for display on the display of the consumer device 110. The motivational content items provide incentives to the user to avoid the abandonment of the shopping cart. It should be noted that multiple motivational content items can be selected, where each selected motivational content item may be displayed in response to a different display threshold value or in response to the same threshold value. For example, a first content item may display a discount of 5%, if the user does not respond to the first content item within 5 seconds, a second content item offering both a 5% discount and free shipping is provided. In addition, a content item showing the inventory for the product or a time window to complete the transaction may be displayed as well.

In S280, it is checked whether to continue (e.g., based on an updated contents of a shopping cart) with the operation and if so, execution continues with S210; otherwise, execution terminates.

In a non-limiting example, the e-commerce server 130 receives and acknowledges a log on of a user onto Amazon.com®. A message indicating that the user adds a sweater to an electronic shopping cart is identified. Then the e-commerce server 130 is configured to collect user-activity parameters related to the total price of the products the user has added to the electronic shopping cart and the time that the sweater placed in the cart. An analysis of the received parameters determines that the amount of time elapsed since the user added the sweater to the electronic shopping cart is significantly more than the time it takes to complete a transaction, and thereby it is identified that the user is about to abandon the cart. The identification may be based on the significant parameter set based on a behavior baseline. In response to the identification, a widget which contains a time-sensitive price discount for the sweater is selected. This widget is displayed on the user's consumer device 110 via the webpage.

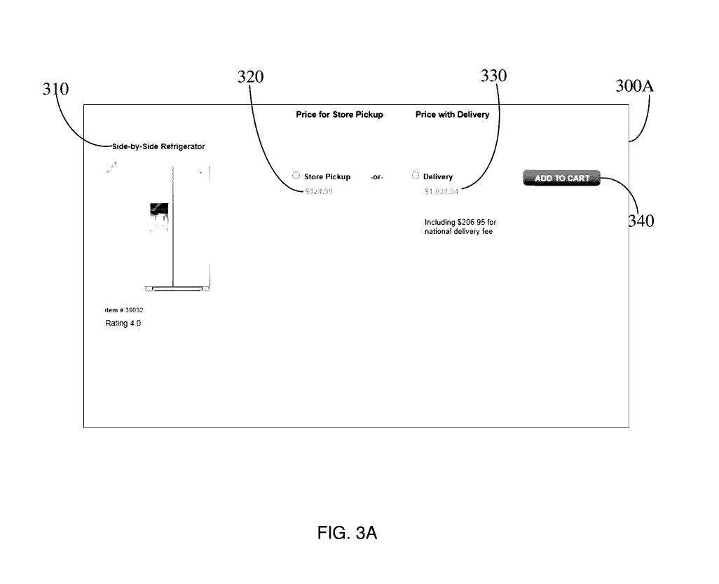

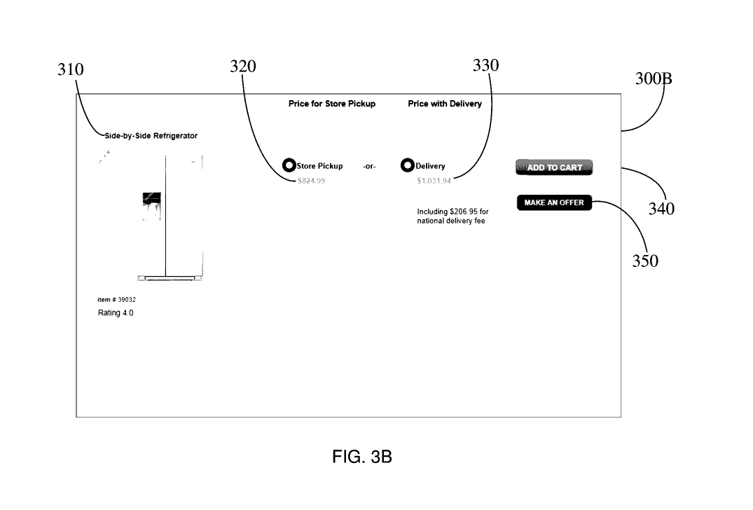

FIGS. 3A and 3B depict exemplary and non-limiting screenshots 300A and 300B, respectively, showing the display of a motivational content item. An e-commerce webpage 300A is shown, comprising an image and a description of a Side-by-Side refrigerator 310. The webpage 300A further comprises two prices for the refrigerator: a price for store pickup 320 and a price that includes the delivery cost to the user's residence 330. The webpage 300A shows a user selection of the “delivery” option 330. The webpage 300A further shows an “add to cart” button 340 to place the refrigerator in an electronic shopping cart.

The web-page 300B shows that the user changed the selection and unchecked the “delivery” option (330). In response, a motivational content item in a form of a link 350 through which the user can make a counter offer is displayed in the web-page 300B under the “add to cart” button 340. The link 350 may be placed in any part of a webpage and is not limited by this example.

The various disclosed embodiments are implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the of the disclosed embodiments and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for preventing electronic shopping cart abandonment in an electronic commerce (e-commerce) website, comprising:
receiving by an e-commerce server a message that at least one product is added to an electronic shopping cart of the e-commerce website displayed on a consumer device;
collecting by the e-commerce server at least one user-activity parameter related to a user of the consumer device;
identifying, using the at least one user-activity parameter, an attempt of a user of the consumer device not to complete a purchase transaction of the at least one product;
selecting at least one motivational content item for display on the consumer device; and
causing a display of the selected at least one motivational content item on a display of the consumer device.

2. The method of claim 1, wherein the at least one user-activity parameter is at least one of: behavioral information related to the user, demographic information, a time that the at least one product added to the cart, and shopping history.

3. The method of claim 1, wherein the message is received from any one of: the consumer device, a web source hosting the e-commerce website.

4. The method of claim 1, further comprising:
collecting at least one product-related parameter from a merchant device.

5. The method of claim 4, wherein the at least one product-related parameter includes at least one of: a type of product, a product price, shipping costs, a minimum price for the product, a minimum margin for the product, and an inventory level of the product.

6. The method of claim 1, wherein the identification of a user attempt not to complete a purchase transaction is based on at least one of: an explicit identification, and an implicit identification.

7. The method of claim 6, wherein determining the implicit identification further comprises:
comparing each of the at least one user-activity parameter to a baseline;
generating a significant parameter for each user-activity parameter being deviate from the respective baseline by a predefined threshold, the implicit identification is determined upon generation of at least one significant parameter.

8. The method of claim 5, wherein the at least one motivational content item is selected based on at least one of the user-activity and the product related parameter.

9. The method of claim 5, wherein the at least one motivational content item is selected via the merchant device of the merchant.

10. The method of claim 1, wherein the at least one motivational content item is designed to incentivize the user to complete the purchase transaction.

11. The method of claim 1, wherein the at least one motivational content item includes at least a link inviting the user to make a counter offer on the product in interest.

12. A non-transitory computer readable medium having stored thereon instructions for causing one or more processing units to execute the method according to claim 1.

13. A system for preventing electronic shopping cart abandonment in an electronic commerce (e-commerce) server website, comprising:
a processing system; and,
a memory coupled to the processing system, the memory containing instructions that, when executed by the processing system, configure the system to:
receive by an e-commerce server a message that at least one product is added to an electronic shopping cart of an e-commerce website displayed on a consumer device;
collect by the e-commerce server at least one user-activity parameter related to a user of the consumer device;
identify, using the at least one user-activity parameter, an attempt of a user of the consumer device not to complete a purchase transaction of the at least one product;
select at least one motivational content item for display on the consumer device; and
cause a display of the selected at least one motivational content item on a display of the consumer device.

14. The system of claim 13, wherein the at least one user-activity parameter is at least one of: behavioral information related to the user, demographic information, a time that the at least one product added to the cart, and shopping history.

15. The system of claim 13, wherein the message is received from any one of: the consumer device, a web source hosting the e-commerce website.

16. The system of claim 13, wherein the system is further configured to:
collect at least one product-related parameter from a merchant device.

17. The system of claim 16, wherein the at least one product-related parameter includes at least one of: a type of product, a product price, shipping costs, a minimum price for the product, a minimum margin for the product, and an inventory level of the product.

18. The system of claim 13, wherein the identification of a user attempt not to complete a purchase transaction is based on at least one of: an explicit identification, and an implicit identification.

19. The system of claim 18, wherein in determining the implicit identification the system is further configured to:
compare each of the at least one user-activity parameter to a baseline;
generate a significant parameter for each user-activity parameter being deviate from the respective baseline by a predefined threshold, the implicit identification is determined upon generation of at least one significant parameter.

20. The system of claim 17, wherein the at least one motivational content item is selected based on at least one of the user-activity and the product related parameter.

21. The system of claim 17, wherein the at least one motivational content item is selected via the merchant device of the merchant.

22. The system of claim 13, wherein the at least one motivational content item is designed to incentivize the user to complete the purchase transaction.

23. The system of claim 13, wherein the at least one motivational content item includes at least a link inviting the user to make a counter offer on the product in interest.
